(19) United States
(12) Patent Application Publication
(10) Pub. No.: US 2002/0128928 A1
(43) Pub. Date: Sep. 12, 2002

(54) Music distribution method for distributing production such as music, server used for said music distribution method, and music reproduction apparatus

(76) Inventor: Hiroshi Sukegawa, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/092,895

(22) Filed: Mar. 8, 2002

(30) Foreign Application Priority Data
Mar. 9, 2001 (JP) 2001-067230

(51) Int. Cl. G06F 17/60

(52) U.S. Cl. 705/26

(57) ABSTRACT

A music distribution method according to one aspect of the present invention comprises requesting a server to distribute music information by a music reproduction apparatus through a communication medium, generating by the server a distribution file in which the requested music information and information concerning settings and conditions required for transmitting information from the music reproduction apparatus to the server, distributing the distribution file to the music reproduction apparatus by the server through the communication medium, and receiving by the server through the communication medium a number of times of reproduction of the music information reproduced by the music reproduction apparatus.

### CROSS-REFERENCE TO RELATED APPLICATIONS

This application is based upon and claims the benefit of priority from the prior Japanese Patent Application No. 2001-067230, filed Mar. 9, 2001, the entire contents of which are incorporated herein by reference.

### BACKGROUND OF THE INVENTION

1. Field of the Invention

The present invention relates to a music distribution method which distributes a production such as music to a consumer by using a communication medium such as the Internet or a storage medium such as a CD or a DVD.

2. Description of the Related Art

There has been conventionally existed a music distribution method which distributes music information to a consumer who listens to music (which will be referred to as a listener hereinafter) by using the Internet or the like. The music information is formed as data so that music can be transmitted/received by using a communication medium, recorded by a storage medium, or reproduced by a reproduction apparatus.

This music distribution method electronically substitutes for the idea of purchasing a compact disc (CD) on which music information is recorded, and the music information is dealt as a purchased good. Therefore, the music distribution method is far from expectation of listeners in terms of prices, and the business scale can not be enlarged.

Further, copy protection for preventing copy is required for the music information to be distributed, which deteriorates usability during reproduction of music. Furthermore, distributed music information is falsely copied and utilized for reproduction of music, thereby generating serious prejudice to copyright holders.

### BRIEF SUMMARY OF THE INVENTION

According to one aspect of the present invention, there is provided a music distribution method comprising: requesting a server to distribute music information from a music reproduction apparatus through a communication medium; generating by the server a distribution file integrating the requested music information and information concerning settings and conditions required for transmitting information from the music reproduction apparatus to the server; distributing by the server the distribution file to the music reproduction apparatus through the communication medium; and receiving by the server through the communication medium a number of times of reproducing the music information reproduced by the music reproduction apparatus.

According to another aspect of the present invention, there is provided a music reproduction apparatus which reproduces music information distributed from a server, the music reproduction apparatus comprising: means for requesting the server to distribute the music information through a communication medium; means for receiving from the server through the communication medium a distribution file integrating the music information requested to be distributed and information concerning settings and conditions required for transmitting information from the music reproduction apparatus to the server; means for reproducing the music information in the distribution file; means for recording a number of times of reproduction of the reproduced music information; and means for transmitting a number of times of reproduction of the music information to the server through the communication medium.

### BRIEF DESCRIPTION OF THE SEVERAL VIEWS OF THE DRAWING

FIG. 1 is a hardware structural view showing a music distribution system according to a first embodiment of the present invention;

FIG. 2 is a hardware structural view showing a music distribution system according to a modification of the first embodiment;

FIG. 3 is a block diagram showing a structure of a server in the music distribution system according to the first embodiment;

FIG. 4 is a block diagram showing transmission/reception of information in the music distribution system according to the first embodiment;

FIG. 5 is a schematic view showing a first example of a file structure of a music distribution file distributed in the music distribution system according to the first embodiment;

FIG. 6 is a schematic view showing a second example of a file structure of a music distribution file distributed in the music distribution system according to the first embodiment;

FIG. 7 is a schematic view showing a third example of a file structure of a music distribution file distributed in the music distribution system according to the first embodiment;

FIG. 8 is a hardware structural view showing a music distribution system according to a second embodiment of the present invention;

FIG. 9 is a hardware structural view showing a music distribution system according to a third embodiment of the present invention;

FIG. 10 is a hardware structural view showing a music distribution system according to a seventh embodiment of the present invention;

FIGS. 11 and 12 are block diagrams showing structures of a portable terminal in the music distribution system according to the seventh embodiment;

FIG. 13 is a flowchart showing the operation in the music distribution system according to the seventh embodiment;

FIG. 14A is a graph showing a threshold voltage distribution and a regular reading voltage of a prior art flash memory;

FIG. 14B is a graph showing a threshold voltage distribution and a reading voltage at the time of occurrence of a random number of a non-volatile memory according to an eighth embodiment of the present invention; and

FIGS. 15A to 15E are schematic views of a memory structure showing a series of operations of the non-volatile memory according to the eighth embodiment.

### DETAILED DESCRIPTION OF THE INVENTION

Embodiments according to the present invention will now be described with reference to the accompanying drawings.

First Embodiment

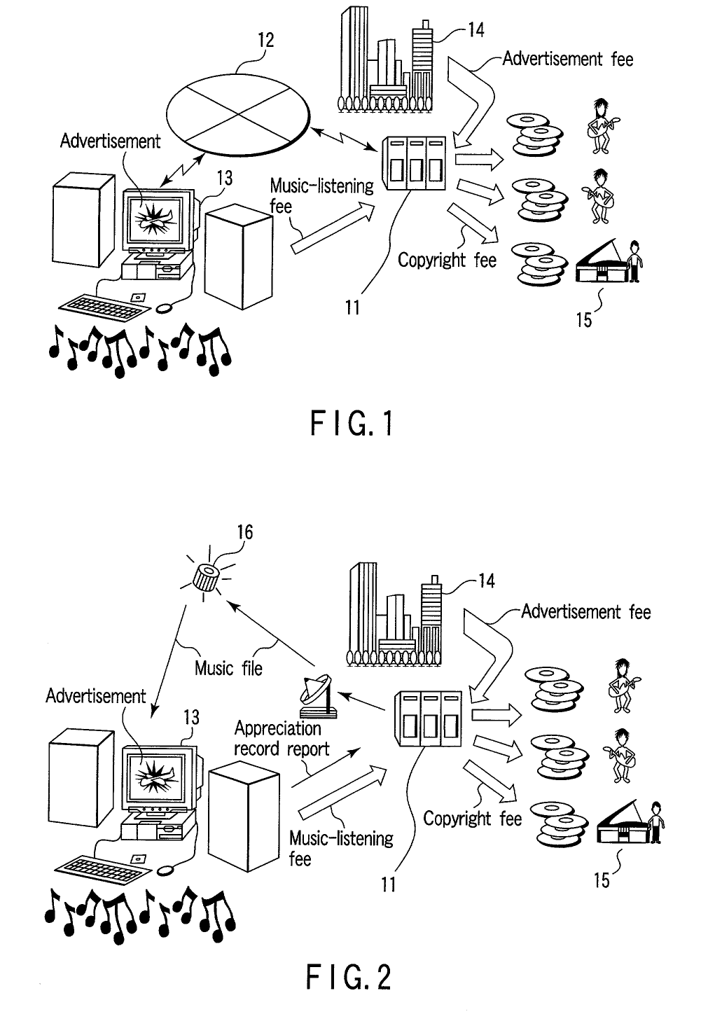

Description will be first given as to a hardware structure of a music distribution system according to a first embodiment of the present invention. FIG. 1 is a view showing a hardware structure of a music distribution system according to the first embodiment.

As shown in FIG. 1, a server 11 of a distribution collection administration company (which will be referred to as an administration company hereinafter) is connected to the Internet 12 through a communication line. To the Internet 12 are connected a plurality of music reproduction apparatuses 13 through the communication line.

The music reproduction apparatus 13 is an apparatus having a reproduction device capable of reproducing music information or an image display portion capable of displaying an image, and this indicates, e.g., a personal computer (which will be referred to as a PC hereinafter).

The server 11 transmits data requesting payment of a music-listening fee to the music reproduction apparatus 13, and a listener pays the music-listening fee to the administration company. Further, the server 11 transmits to an advertiser 14 data requesting payment of an advertisement fee, and the advertiser 14 pays the advertisement fee to the administration company. Then, the administration company pays a copyright fee to a music information copyright holder 15.

Furthermore, FIG. 2 is a view showing another hardware structure of the music distribution system. Although an example of transmission/reception of information by using the Internet 12 is shown in the hardware structure of FIG. 1, information may be distributed by using communication by a satellite 16 as illustrated in FIG. 2. Moreover, although not shown, information (music information) may be distributed by using a storage medium such as a CD or a DVD.

The structure in the server 11 provided in the administration company will now be described.

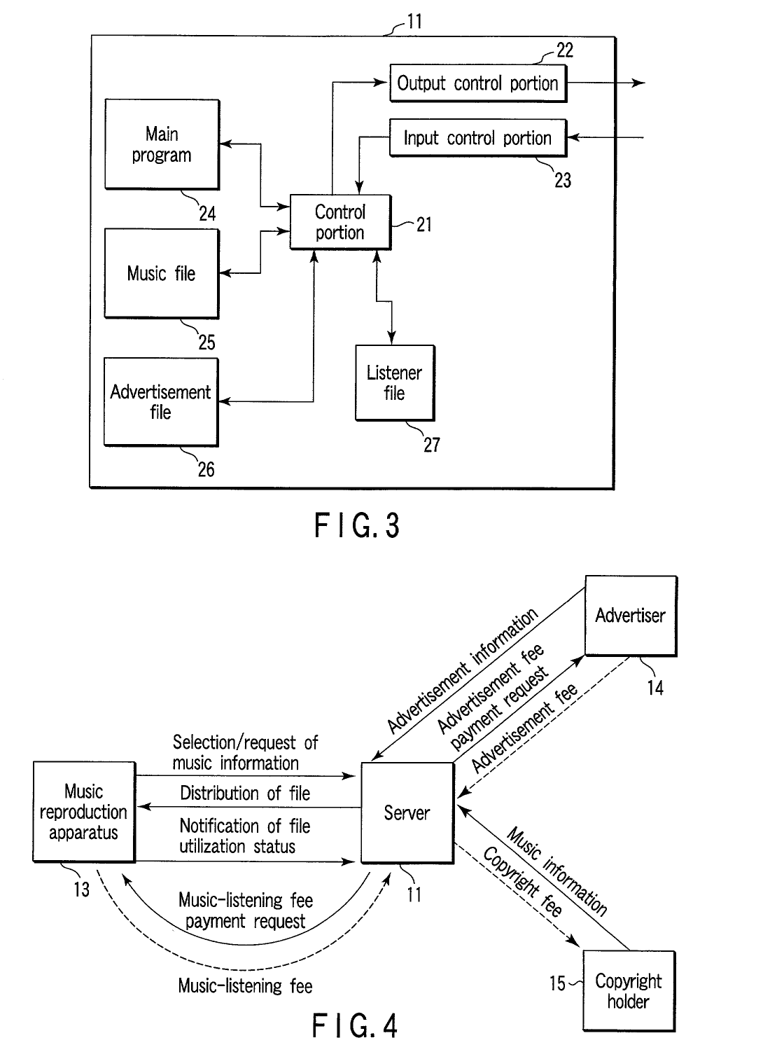

FIG. 3 is a block diagram showing a structure of the server 11.

A control portion 21 consists of an arithmetic operation processing device such as a CPU, and executes control over each part in the server, various kinds of arithmetic operation processing, data transfer, temporary storage of data and others. An output control portion 22 stores and controls data outputted to the music reproduction apparatus 13 through the Internet 12. An input control portion 23 stores and controls data inputted from the music reproduction apparatus 13 through the Internet 12. Storing means in the server 11 stores therein a main program 24, a music file 25, an advertisement file 26, a listener file 27, respectively.

A plurality of sets of music information are stored in the music file 25. The music information is information which takes the form of data so that music can be transmitted through a communication medium such as the Internet. A plurality of sets of advertisement information are stored in the advertisement file 26. The advertisement information is information which takes the form of data so that the advertisement provided by an advertiser can be transmitted through a communication medium such as the Internet.

The main program 24 is a program processed by the control portion 21, and constituted by, for example, a program which displays a guidance screen for performing music distribution on the music reproduction apparatus 13 and executes a series of processing according to the guidance screen, a program which generates a music distribution file integrating music information in the music file 25, advertisement information in the advertisement file 26 and information of connection to the server 11, a program which is used for distributing the music distribution file to the music reproduction apparatus 13, a program which creates and manages listener data in the listener file 27, and others. The information of connection to the server 11 is information concerning settings or conditions for transmitting information from the music reproduction apparatus 13 to the server 11 and stored in a main program 24. The information concerning the settings or conditions includes, for example, an Internet IP address which is required for the music reproduction apparatus to transmit information such as appreciation records to the server, and others.

The listener file 27 stores therein a plurality of sets of listener data. The listener data is a record of information of each listener and constituted by items of, e.g., a listener identification number, music information, advertisement information, appreciation records (number of times of reproduction) and others. The listener data is created in accordance with each music reproduction apparatus 13 used by a listener.

The operation of the music distribution system shown in FIG. 1 will now be described.

FIG. 4 is a block diagram showing transmission/reception of information in the music distribution system.

The music reproduction apparatus (listener) 13 requests the server 11 of the administration company to distribute desired music information. Alternatively, the server 11 transmits to the music reproduction apparatus 13 a list of music information which can be distributed. The music reproduction apparatus (listener) 13 selects music information from the received list of music information and requests distribution of that selected music information.

The server 11 creates a music distribution file in which the requested music information, the advertisement information, and the information of connection to the server 11 are integrated, and distributes the music distribution file to the music reproduction apparatus 13.

Subsequently, the music reproduction apparatus (listener) 13 reproduces the music information and listens to the music. At this moment, the music reproduction apparatus 13 reproduces the advertisement information with reproduction of the music information, and carries out the advertising action. As an example of the advertising action, there are display of advertisement in a screen of the music reproduction apparatus 13, audio output of advertisement with announcement of a song title of the music to be reproduced, and others. A timing for reproducing the advertisement information may be before or after reproduction of the music information. In addition, during reproduction of the music information, it is possible to carry out reproduction of the advertisement information, for example, display of advertisement in the screen.

The music reproduction apparatus 13 repeatedly carries out reproduction of the music information and the advertisement information at a listener's request. The music reproduction apparatus 13 records and manages a number of times of reproduction of the reproduced music information and a number of times of reproduction of the reproduced advertisement information. Then, the utilization status of the music information and the advertisement information is transmitted at a predetermined frequency from the music reproduction apparatus 13 or a PC or the like to which a portable type music reproduction terminal (which will be referred to as a portable terminal hereinafter) is occasionally connected to the server 11 of the administration company. That is, the appreciation records (number of times of reproduction) are reported from the music reproduction apparatus 13 to the server 11.

Then, the server 11 of the administration company transmits data requesting payment of the advertisement fee to the advertiser 14 in accordance with the utilization status (appreciation records) of the advertisement information. In this case, the server 11 may transmit to a receiver owned by the advertiser 14 or a bank account owned by the advertiser 14 the data requesting payment. Additionally, payment of an advertisement fee may be requested to the advertiser 14 by mail or the like. The advertiser 14 pays the advertisement fee according to the utilization status (appreciation records) to the administration company.

Further, the server 11 of the administration company transmits data requesting payment of a music-listening fee to the music reproduction apparatus (listener) 13 in accordance with the utilization status (appreciation records) of the music information and the advertisement information. In this case, the server 11 may transmit the data requesting payment to the music reproduction apparatus 13 or a bank account of a listener who owns the music reproduction apparatus 13 through a communication medium. Furthermore, payment of the music-listening fee may be requested to the listener by mail or the like. The listener pays the music-listening fee according to the utilization status (appreciation records) to the administration company.

As sources of income of the administration company, there are two sources, namely, an advertisement fee by advertisement and general publicity carried out with reproduction of music and a music-listening fee paid by a listener in accordance with the appreciation records. Moreover, the administration company pays a copyright fee to the music information copyright holder 15 in accordance with the music information utilization status (appreciation records).

In addition, advertisement information is previously provided from the advertiser 14 to the server 11 of the administration company and stored in the advertisement file 26. Music information is provided from a copyright holder 15 and stored in the music file 25.

Incidentally, although description has been given as to a method for distributing a music distribution file by using the Internet here, the present invention is not restricted thereto, and a music distribution file may be distributed by using a satellite as shown in FIG. 2. Alternatively, a music distribution file may be distributed by using a storage medium such as a CD-ROM, a DVD-ROM or the like.

A file structure of a music distribution file distributed by the administration company will now be described.

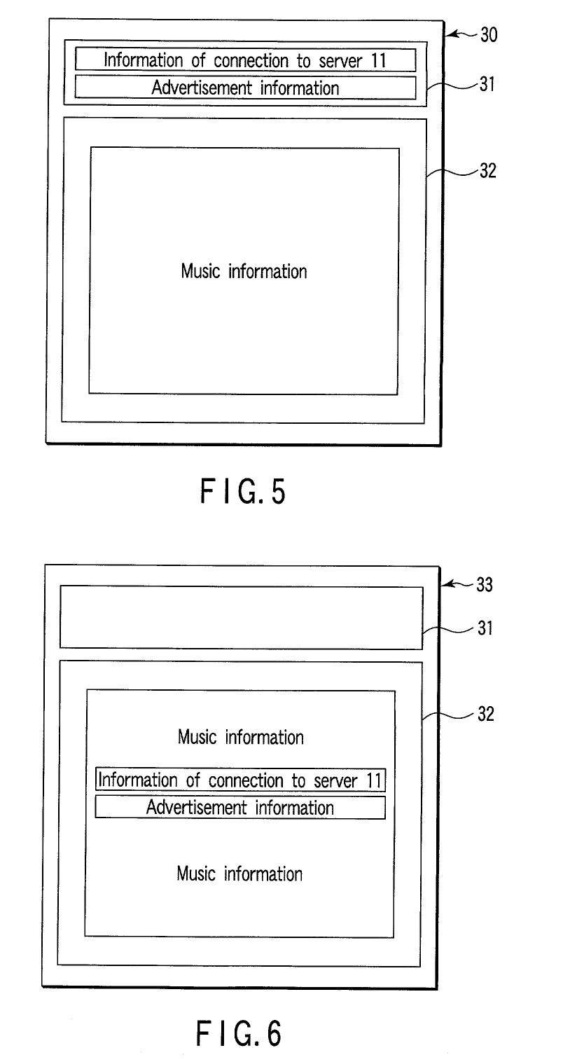

FIG. 5 is a view showing a first example of a file structure of the music distribution file.

The music distribution file 30 distributed by the server 11 of the administration company has a structure that information of connection to the server 11 (for example, information including an Internet address) and advertisement information (for example, information which can be read as text) are recorded in a header information portion 31 of the file and music information is recorded in a main body information portion 32 under the header information portion 31.

Additionally, the main body information portion 32 may include specific data which can specify information in the header information portion 31, namely, specific data which can specify the information of connection to the server 11 and the advertisement information, besides the music information. In this case, when the information of connection to the server 11 and the advertisement information in the header information portion 31 coincide with the specific data in the main body information portion 32, the music information can be reproduced in the environment of an application allowing reproduction of the music information. Incidentally, it is good enough to scramble the specific data in advance.

By adopting such a file structure for the music distribution file, the information of connection to the server 11 and the advertisement information can be read from the header information portion 31 by an application to which security countermeasures are not taken in particular. On the other hand, when the information in the header information portion 31 is malignantly tampered, reproduction can be rejected on the main body information portion 32 side which has a security function and the music information recorded therein. As described above, it is good enough to provide the specific data to the main body information portion 32 so that tampering is difficult in such a manner that whether information in the header information portion 31 is tampered can be checked.

A second example of the file structure of the music distribution file will now be described.

FIG. 6 is a view showing the second example of the file structure of the music distribution file.

The music distribution file 33 distributed by the server 11 has a structure that the information of connection to the server 11 and the advertisement information are not recorded in the header information portion 31 of the file, the music information is recorded in the main body information portion 32 under the header information portion 31, and the information of connection to the server 11 and the advertisement information are included only in the music information.

The music reproduction apparatus 13 carries out an advertising action with reproduction of the music information in accordance with the advertisement information recorded in the music information. Further, the music reproduction apparatus 13 connects to the server 11 of the administration company in accordance with the information of connection to the server 11 recorded in the music information, and informs the appreciation records (number of times of reproduction) of the music information and the advertisement information.

A third example of the file structure of the music distribution file will now be described.

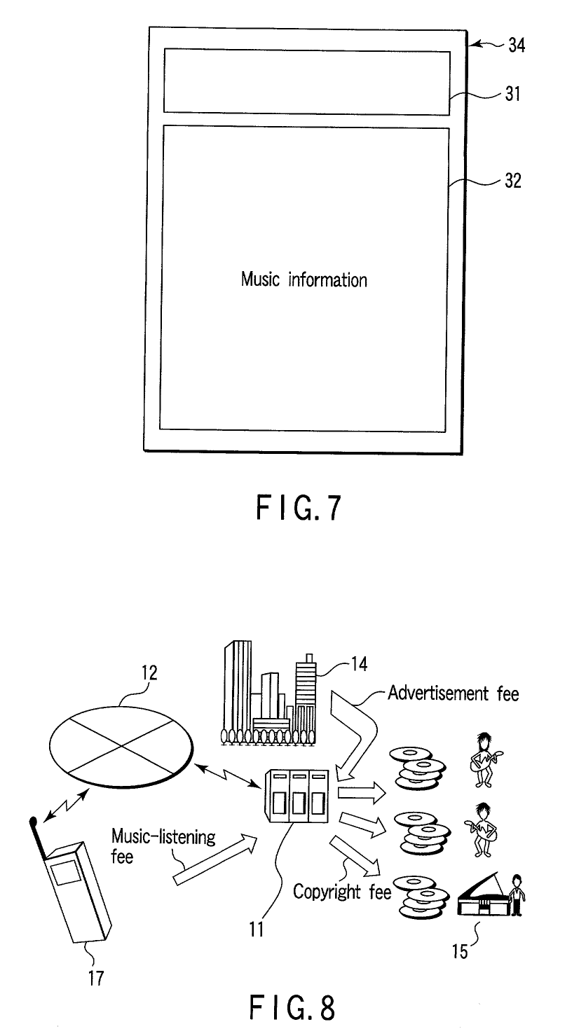

FIG. 7 is a view showing a third example of the file structure of the music distribution file.

The advertisement information is not recorded in the music distribution file 34 distributed by the server 11. The advertisement information is distributed to and stored in the music reproduction apparatus 13 in advance. The music information is recorded in the main body information portion 32 below the header information portion 31 of the music distribution file 34.

The music information to be reproduced and the advertisement information to be reproduced at the same time are determined in accordance with association information associating the music information with the advertisement information. This association information is distributed separately from the music distribution file. At this moment, there may be or may not be any relevance between the music information and the advertisement information to be associated with each other.

There are examples of providing the relevance between the music information and the advertisement information as follows. There is a case of matching the user population preferring a specific music tile with the user population to which advertisement should be performed, or a case of associating the advertisement information with each genre depending on music in a specific genre.

Furthermore, there are examples of providing no relevance between the music information and the advertisement information as follows. There is a case that a specific advertisement should be given in favor with a specific timing at a specific time irrespective of music information to be reproduced, or a case of determining the advertisement information to be reproduced depending on a time zone in day that a listener is listening.

Even in the case that the music information and the advertisement information to be reproduced do not necessarily have the relevance, which advertisement information is reproduced as an advertisement during appreciation of which music information is recorded each time by the music reproduction apparatus 13 and reported to the server 11 of the administration company at an appropriate frequency as appreciation records.

As described above, according to the first embodiment, the music reproduction apparatus 13 records numbers of times of reproduction of the music information and the advertisement information, and the numbers of times of reproduction are transmitted to the server 11 at a predetermined frequency. As a result, a music-listening fee paid by a listener can be collected in accordance with the music appreciation records (number of times of reproduction), and a copyright fee can be paid to the copyright holder 15 in accordance with the appreciation records. Furthermore, income of the advertisement fee is obtained in accordance with a number of times of reproduction of the advertisement information, thereby reducing the music-listening fee.

Second Embodiment

A music distribution system according to a second embodiment of the present invention will now be described.

In the second embodiment, description will be given as to an example of using a portable music reproduction terminal (which will be referred to as a portable terminal hereinafter) as the music reproduction apparatus.

FIG. 8 is a view showing a hardware structure of a music distribution system according to the second embodiment.

The hardware structure according to the second embodiment uses a portable terminal 17 in place of the music reproduction apparatus (for example, a PC) 13 in the structure illustrated in FIG. 1, and any other structure is similar to the first embodiment.

In the second embodiment, the music information is associated with the advertisement information by in one-to-one relationship, one set of the advertisement information is reproduced with reproduction of one set of the music information, and an advertising action is carried out. It is to be noted that one set of the music information may be associated with a plurality of sets of the advertisement information and a plurality of the sets of the advertisement information may be reproduced with reproduction of the one set of the music information.

The portable terminal (listener) 17 requests the server 11 of the administration company to distribute desired music information. Alternatively, the server 11 transmits to the portable terminal 17 a list of the music information which can be distributed. The portable terminal (listener) 17 requests distribution of desired music information in the received list of the music information.

The server 11 creates a music distribution file in which the requested music information, the advertisement information and the information of connection to the server 11 are integrated, and distributes the music distribution file to the portable terminal 17.

Subsequently, the portable terminal 17 (listener) 17 reproduces the music information and a listener listens to the music. At this moment, the portable terminal 17 reproduces the advertisement information with reproduction of the music information and carries out an advertising action. As examples of the advertising action, there are display of the advertisement in the screen of the portable terminal 17, audio output of the advertisement with announcement of a song title of the music to be reproduced, and others. A timing for reproducing the advertisement information may be before or after reproduction of the music information. Furthermore, during reproduction of the music information, it is possible to perform reproduction of the advertisement information, for example, display of the advertisement in the screen.

The portable terminal 17 repeatedly carries out reproduction of the music information and the advertisement information at a listener's request. The portable terminal 17 records and manages a number of times of reproduction of the reproduced music information and a number of times of reproduction of the reproduced advertisement information. Then, when counterchanging the music information distributed to the portable terminal 17, the portable terminal 17 transmits the utilization status of the music information and the advertisement information to the server 11 of the administration company 11. That is, appreciation records (number of times of reproduction) are reported from the portable terminal 17 to the server 11.

Subsequently, the server 11 of the administration company transmits data requesting payment of an advertisement fee to the advertiser 14 in accordance with the utilization status (appreciation records) of the advertisement information (appreciation records). The advertiser 14 pays the advertisement fee according to the utilization status to the administration company.

Moreover, the server 11 of the administration company transmits data requesting payment of a music-listening fee to the portable terminal (listener) 17 in accordance with the utilization status of the music information and the advertisement information (appreciation records). The listener pays the music-listening fee according to the utilization status to the administration company.

As sources of income for the administration company, there are two sources, namely, an advertisement fee by the advertisement and general publicity carried out with reproduction of music and a music-listening fee paid by a listener in accordance with appreciation records. In addition, the administration company pays a copyright fee to the music information copyright holder 15 in accordance with the utilization status (appreciation records) of the music information.

As described above, according to the second embodiment, the portable music reproduction terminal 17 records a number of times of reproduction of the music information and the advertisement information and transmits the number of times of reproduction to the server 11 at a predetermined frequency. As a result, a music-listening fee paid by a listener can be collected in accordance with the music appreciation records (number of times of reproduction), and a copyright fee can be paid to the copyright holder 15 in accordance with the appreciation records. In addition, the music-listening fee can be reduced by obtaining income of the advertisement fee in accordance with a number of times of reproducing the advertisement information.

Third Embodiment

A music distribution system according to a third embodiment of the present invention will now be described.

In the third embodiment, description will be given on an example of using a portable music reproduction terminal (which will be referred to as a portable terminal hereinafter) as the music reproduction apparatus, as similar to the second embodiment.

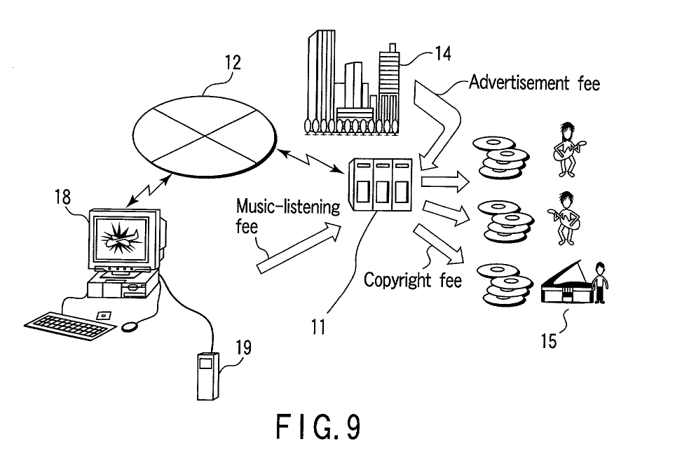

FIG. 9 is a view showing a hardware structure of a music distribution system according to the third embodiment.

The hardware structure of the third embodiment uses a transmission/reception device 18 such as PC and a portable terminal 19 in place of the music reproduction apparatus in the structure illustrated in FIG. 1, and any other structure is similar to the first embodiment.

The transmission/reception apparatus 18 requests the server 11 of the administration company to distribute desired music information. Alternatively, the server 11 transmits to the transmission/reception device 18 a list of music information which can be distributed. The transmission/reception apparatus 18 requests distribution of the desired music information in the received list of music information.

The server 11 creates a music distribution file in which the requested music information and advertisement information are integrated, and distributes the music distribution file and information of connection to the server 11 to the transmission/reception device 18. The portable terminal 19 connected to the transmission/reception device 18 fetches and stores the music information and the advertisement information distributed to the transmission/reception device 18 into the portable terminal 19.

Subsequently, the portable terminal (listener) 19 reproduces the music information and listens to the music. At this moment, the portable terminal 19 reproduces the advertisement information with reproduction of the music information and carries out an advertising action. A timing for reproducing the advertisement information may be before or after reproduction of the music information. Further, it is possible to perform reproduction of the advertisement information, for example, display the advertisement in the screen during reproduction of the music information.

The portable terminal 19 repeatedly carries out reproduction of the music information and the advertisement information at the listener's request. Furthermore, in order to counterchange the music information recorded in the portable terminal 19, the transmission/reception device 18 confirms what the music information recorded in the portable terminal 19 is when the portable terminal 19 is connected to the transmission/reception device 18, and calculates an estimated value of a number of times of reproduction of the music information and the advertisement information based on a staying time of the music information in the portable terminal 19. The portable terminal 19 transmits the estimated value to the server 11 of the administration company. The server 11 regards the received estimated value as the appreciation records of the music information and the advertisement information.

Subsequently, the server 11 of the administration company transmits data requesting payment of an advertisement fee to the advertiser 14 in accordance with a utilization status of the advertisement information (appreciation records). The advertiser 14 pays the advertisement fee according to the utilization status to the administration company.

Moreover, the server 11 of the administration company transmits data requesting payment of a music-listening fee to the portable terminal (listener) 19 in accordance with a utilization status of the music information and the advertisement information (appreciation records). The listener pays the music-listening fee according to the utilization status to the administration company.

As sources of income for the administration company, there are two sources, i.e., the advertisement fee by the advertisement and general publicity carried out with the music reproduction and the music-listening fee paid by the listener in accordance with the appreciation records, as described above. In addition, the administration company pays a copyright fee to the music information copyright holder 15 in accordance with the utilization status of the music information (appreciation records).

In this embodiment, the portable terminal 19 performs only reproduction of the music information and the advertisement information but does not record a number of times of reproduction of the music information and the advertisement information. As a result, the portable terminal 19 can reduce the load required for recording a number of times of reproduction.

Fourth Embodiment

A music distribution system according to a fourth embodiment of the present invention will now be described.

In the fourth embodiment, description will be given as to an example of changing an output content of the advertisement in accordance with an output mode of the music reproduction apparatus by using a music distribution file in which music information, information of connection to the server of the administration company and advertisement information are integrated.

For example, in case of reproducing the music information and the advertisement information by a PC, the advertisement is displayed in the form of an image or banner advertising which can be linked on the Internet. When reproducing such information in the portable terminal, the advertisement is displayed in the form of characters or inserted into the outset of the music as voices. In this manner, variations, e.g., changing the output content of the advertisement can be taken in accordance with the output mode of the music reproduction apparatus.

Thus, the music reproduction apparatuses are first classified by category based on the advertisement expression capability. A plurality of sets of the advertisement information corresponding to a plurality of the music reproduction apparatuses classified by category are created. Then, a plurality of the sets of the advertisement information are included in the main body of the music distribution file in which the music information to be distributed, the connection information and the advertisement information are integrated. As a result, a change in the output content of the advertisement is enabled in accordance with the output mode of the music reproduction apparatus. On the contrary, the music reproduction apparatus corresponding to this system must be provided with the advertisement expression capability comparable to any one of predetermined categories.

Fifth Embodiment

A music distribution system according to a fifth embodiment will now be described. The fifth embodiment is a modification of the first embodiment, and description will be given based on FIG. 1.

The server 11 of the administration company previously distributes information of connection to the server 11 and a plurality of sets of advertisement information to the music reproduction apparatus 13 of a listener, who listens to music, through the internet 12, and stores them in the music reproduction apparatus 13. Further, the server 11 distributes music information to the music reproduction apparatus 13. In this case, the music information and the advertisement information are not integrated in a file.

Subsequently, the music reproduction apparatus (listener) 13 listens to music by reproducing the music information. At this moment, the music reproduction apparatus 13 reproduces the advertisement information with reproduction of the music information and carries out an advertising action. During reproduction of the advertisement information, the listener selects any set of the advertisement information to be reproduced from a plurality of the sets of the advertisement information during reproduction of the advertisement information.

By enabling selection of the advertisement information, the administration company must provide the advertisement with the higher quality. Therefore, elements of competition for heightening the quality of the advertisement act, and the listener does not jib at accepting the advertisement and general publicity as a result of increase in the quality of the advertisement, which is effective for orientation of market expansion. A timing for performing reproduction of the advertisement information may be before or after reproduction of the music information. Furthermore, during reproduction of the music information, it is possible to carry out reproduction of the advertisement information, for example, display of the advertisement in the screen.

As an example of this embodiment, there is the following method.

The copyright holder 15 distributes the music information which is a production owned by him/herself to the music reproduction apparatus 13 of a listener. The server 11 of the administration company distributes to the music reproduction apparatus 13 an advertisement file including a plurality of sets of advertisement information and information required for the advertisement utilization status notifying function. The music reproduction apparatus 13 can not reproduce the music information solely, and reproduction of the music information can be enabled when this information is combined with the advertisement file distributed by the administration company.

Furthermore, the advertisement file provided by the administration company not only enables reproduction of a specific set of the music information, namely, not only breaks the code of a specific set of the music information but also enables reproduction of universal music information.

Incidentally, although there are variations in compression mode or compression rate of the music information distributed by the copyright holder, there is no variation in file format depending on administration companies. Therefore, there is an advantage that variations in file format of the music information distributed as the same music are not increased.

Moreover, as another example of this embodiment, there is the following method.

The server 11 of the administration company previously distributes dedicated reproduction software to the music reproduction apparatus 13 of a listener who requests distribution of the music information. This reproduction software includes information required for the advertisement utilization status notifying function.

The server 11 of the administration company distributes the advertisement information to the music reproduction apparatus 13. This advertisement information does not have a function for enabling reproduction of the music information (function for decoding the music information).

The copyright holder 15 distributes the music information which is a production owned by himself/herself to the music reproduction apparatus 13 of a listener. The music information itself distributed by the copyright holder 15 has the cryptography property and can not be reproduced by conventional music reproduction software, for example, one which simply decodes the compressed music information. The music information can be reproduced only by the dedicated reproduction software provided by the administration company.

The dedicated reproduction software has a function which monitors that the advertisement information is reproduced and advertisement and general publicity are carried out, confirms that the server 11 of the administration company is informed of a result of monitoring, and determines these contents as conditions for allowing reproduction of music. Therefore, it is good enough for the advertisement information provided by the server 11 of the administration company includes information for enabling execution of a predetermined advertising action, and the advertisement information itself does not need the concealment property.

Incidentally, as described above, the reproduction software has a function for notifying the administration company of a result of carrying out advertisement and general publicity. Thus, the reproduction software can be aware of which administration company is informed, and hence the reproduction software can eliminate the bogus advertisement showing that any notified party is unofficial, for example.

Additionally, at this time, as the operation of the music reproduction software, an administered party, for example, a party to which the music reproduction software is distributed may be caused to report which administration company is notified at an appropriate frequency, thereby preventing fraudulence.

As described above, according to the fifth embodiment, when the server 11 distributes the information of connection to the server 11 and the advertisement information to the music reproduction apparatus 13 and the music reproduction apparatus 13 reproduces the music information, any one in a plurality of sets of the advertisement information can be selected to be reproduced, and elements of competition heightening the quality of the advertisement can thereby act, thus increasing the quality of the advertisement. Consequently, a listener does not jib at accepting the advertisement, which is effective for orientation of market expansion. Further, the music reproduction apparatus 13 records a number of times of reproduction of the music information and the advertisement information and transmits the number of times of reproduction to the server 11 at a predetermined frequency. Therefore, a music-listening fee paid by a listener can be collected in accordance with the music appreciation records (number of times of reproduction), and a copyright fee can be paid to the copyright holder 15 in accordance with the appreciation records. Furthermore, the music-listening fee can be reduced by obtaining income of the advertisement fee in accordance with a number of times of reproducing the advertisement information.

Sixth Embodiment

A music distribution system according to a sixth embodiment will now be described. This sixth embodiment is a modification of the third embodiment, and description will be given with reference to FIG. 9.

The server 11 of the administration company previously distributes information of connection to the server 11 and a plurality of sets of advertisement information to the transmission/reception device 18 through the Internet 12, and stores them.

Furthermore, the transmission/reception device 18 requests the server 11 of the administration company to distribute desired music information. Alternatively, the server 11 transmits to the transmission/reception device 18 a list of music information which can be distributed. The transmission/reception device 18 requests distribution of the desired music information from the received list of the music information. The server 11 distributes the requested music information to the transmission/reception device 18. In this case, the music information and the advertisement information are not integrated in a file.

The portable terminal 19 connected to the transmission/reception device 18 fetches and stores the music information distributed to the transmission/reception device 18 in the portable terminal 19. At this moment, the transmission/reception device 18 reproduces the advertisement information and carries out the advertising action with transmission of the music information to the portable terminal 19.

Subsequently, the portable terminal 19 repeatedly performs reproduction of the music information in accordance with the request of a listener. The portable terminal 19 records and manages a number of times of reproduction of the reproduced music information. Moreover, when counterchanging the music information distributed to the portable terminal 19, the portable terminal 19 transmits a number of times of reproducing the music information to the transmission/reception device 18. At this moment, the transmission/reception device 18 reproduces the advertisement information and performs the advertising action with reception of a number of times of reproduction from the portable terminal 19.

In addition, the transmission/reception device 18 transmits a number of times of reproducing the music information and a number of times of reproducing the advertisement information to the server 11 of the administration company. That is, the portable terminal 19 reports the music information appreciation records (number of times of reproduction) to the server 11, and the transmission/reception device 18 reports a number of times of reproducing the advertisement information to the server 11. The subsequent operation is similar to that of the third embodiment.

Incidentally, although reproduction of the advertisement information by the transmission/reception device 18 is carried out at two points in time, i.e., when transmitting the music information to the portable terminal 19 and receiving a number of times of reproducing the music information from the portable terminal 19, reproduction may be carried out at any one point in time.

Additionally, the advertisement information may be reproduced on another occasion other than these two points in time. In this case, it is good enough to effect the operation (for example, clicking) to the transmission/reception device 18 during reproduction of the advertisement in order to confirm that the advertisement is viewed or listened.

This embodiment concerns reproduction of the advertisement information. It does not reproduce the advertisement information simultaneously with reproduction of the music information, but the advertisement information may be reproduced on another occasion other than reproduction of the music information. That is, if viewing or listening to the advertisement is a counter value to be paid for music appreciation, the advertisement information may be reproduced before and after music appreciation or on any other occasion.

Such an embodiment has the following advantages.

The advertisement which can be carried out simultaneously with music appreciation has images as a main body. Even if acoustic information is inserted, it can not be excessive. As with this embodiment, however, if the advertisement is reproduced on any occasion other than music appreciation, the acoustic information can be satisfactorily included in the advertisement.

As the advertisement effected on any occasion other than music appreciation, there can be considered the advertising or the like aiming at having a listener independently and normally listen to new music information (music content) itself. That is, this is like a preannounce advertisement of new music information.

Further, in the advertisement effected on any occasion other than music appreciation, the advertising action having the sound as a main body is possible. For example, when listening to the audio advertisement streamed during execution of any operation (operation mainly consisting of screen operations) in the transmission/reception device (for example, a PC) 18, the counter value for music appreciation can be paid. In case of such an advertisement, assuming that it is the advertisement of music information, a listener may possibly extemporarily perform operations such as downloading the music information for next music appreciation if he/she likes that music information. As a variation of such an advertisement, it is possible to apply one which comes from the Internet simultaneously with execution of the advertisement (advertisement is reproduced in a stream). That is, if a listener listens to the Internet radio, it can be considered that the counter value for music appreciation can be paid.

Incidentally, in the first to sixth embodiments mentioned above, the music information and the advertisement information are transmitted to the music reproduction apparatus, and the advertisement information is reproduced with reproduction of the music information, or the advertisement information is reproduced on any occasion other than reproduction of the music information, in order to collect an advertisement fee. However, transmission and reproduction of the advertisement information and collection of the advertisement fee may not be carried out, and only collection of the music-listening fee according to a number of times of reproducing the music information by a listener may be a source of income. Furthermore, the music-listening fee according to a number of times of reproduction may not be collected, but a membership system such as a fixed charge or a specific charge may be employed and a membership fee may be collected.

In the present invention, the copy protection which prevents copying on the distributed music information itself is not necessary, and music appreciation is possible without limit in the music distribution system according to the foregoing embodiments. Moreover, copying the music distribution file itself leads to increase of sales for the administration company, such copying should be welcomed.

In addition, distributing the music information which gets in right with one to a broad range of friends or the like has been conventionally a contravention. In this music distribution system, however, such a distribution action is preferable in order to pay a copyright fee to a music copyright holder in accordance with a quantity of music appreciation.

Seventh Embodiment

A music distribution system according to a seventh embodiment will now be described. In this seventh embodiment, description will be given as to a system administered by the membership enabling a plurality of music reproduction apparatuses registered by a member to be provided with a music distribution system when a listener (which will be referred to as members hereinafter) pays a predetermined membership fee. This music distribution system may be administered by only the membership fee without the advertisement income, or may be administered by both the advertisement income and the membership fee. As to the membership fee, a fixed amount of money may be collected as a monthly membership fee or an annual membership fee. That is, this embodiment is a system which proposes the environment that the members can utilize a plurality of the music reproduction apparatuses when the system is administered by the monthly membership fee of a fixed amount with or without the advertisement income. Here, description will be given as to the case where the system is administered by only the membership fee without the advertisement income.

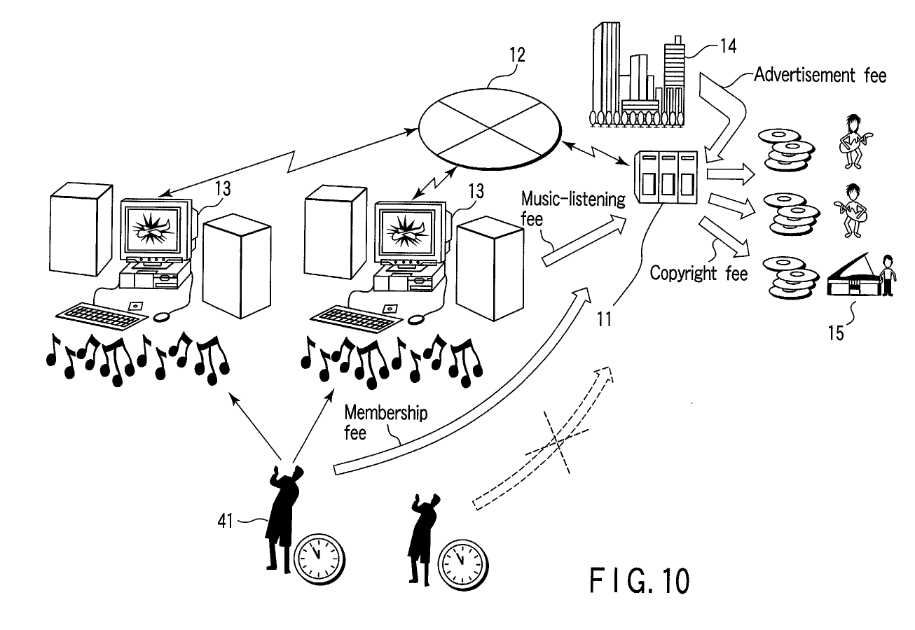

FIG. 10 is a view showing the hardware structure of the music distribution system according to the seventh embodiment.

As shown in FIG. 10, the server 11 of a distribution collection administration company (which will be referred to as an administration company hereinafter) is connected to the Internet 12 through a communication line. To the Internet 12 are connected a plurality of music reproduction apparatuses 13 via the communication line.

A member 41 requests distribution of music information from the music reproduction apparatus 13 through the Internet 12. The music reproduction apparatus 13 has a reproduction device capable of reproducing music information or an image display portion capable of reproducing the music information or displaying an image. For example, it indicates a personal computer (which will be referred to as a PC hereinafter) or a portable music reproduction terminal (which will be referred to as a portable terminal hereinafter). The structure of this portable terminal will be described later.

The server 11 controls communication by the Internet 12, and distributes to the music reproduction terminal 13 the music information by the Internet 12 in response to a request from the music reproduction apparatus 13. The music reproduction apparatus 13 reproduces the distributed music information and records therein the reproduced music information, a number of times of reproduction and a reproduction time as appreciation records. Further, the music reproduction apparatus 13 reports the recorded appreciation results to the server 11 every predetermined time through the Internet.

The server 11 transmits data requesting payment of a copyright fee to the administration company in accordance with the received appreciation records. In response to this payment request, the administration company pays the copyright fee to a copyright holder 15 having the copyright of the music information.

Here, as an example of the music reproduction apparatus 13, the structure of the portable terminal will be described.

FIGS. 11 and 12 are block diagrams showing the structures of the portable terminal. FIG. 11 shows a flow of data when downloading the music information, and FIG. 12 shows a flow of data when reproducing the music information.

As shown in FIG. 11, a LAN interface 42 in the portable terminal 13 is connected to the Internet 12. Music information is distributed to an MPU 43 through the LAN interface 42. The music information is distributed to the MPU 43 through the LAN interface 42. The MPU 43 stores therein the received music information in a first storage portion 44 and stores it in a second storage portion 46 through an ECC code generation portion 45. The first storage portion 44 consists of a non-volatile memory such as a RAM. The second storage portion 46 consists of a non-volatile memory such as an NAND flash memory.

The first storage portion 44 temporarily stores music information, or temporarily stores data required for management and administration of the operation of the second storage portion 46. The ECC code generation portion 45 detects and corrects an error existing in music information outputted from the MPU 43. Further, the music information corrected by the ECC code generation portion 45 is stored in the second storage portion 46.

Further, a flow of data during reproduction of the music information in the portable terminal 13 is as follows.

As shown in FIG. 12, the music information stored in the second storage portion 46 is read to the MPU 43 through the ECC code generation portion 45. The ECC code generation portion 45 generates an ECC code and outputs it to the MPU 43. The MPU 43 compares the music information read from the second storage portion 46 and stored in the first storage portion 44 with the generated ECC code, and corrects the music information stored in the first storage portion 44 according to needs.

Thereafter, the music information stored in the first storage portion 44 is outputted to a DSP 47. The music information inputted in the DSP 47 is decoded to regular data from the compressed data by the DSP 47. The music information outputted from the DSP 47 is temporarily stored in a buffer memory 48, converted from a digital signal into an analog signal by a D/A converter and reproduced. The ECC code generation portion 45 may not be provided in the portable terminal 13 of FIGS. 11 and 12.

Description will now be given as to the operation of the music distribution system shown in FIG. 10.

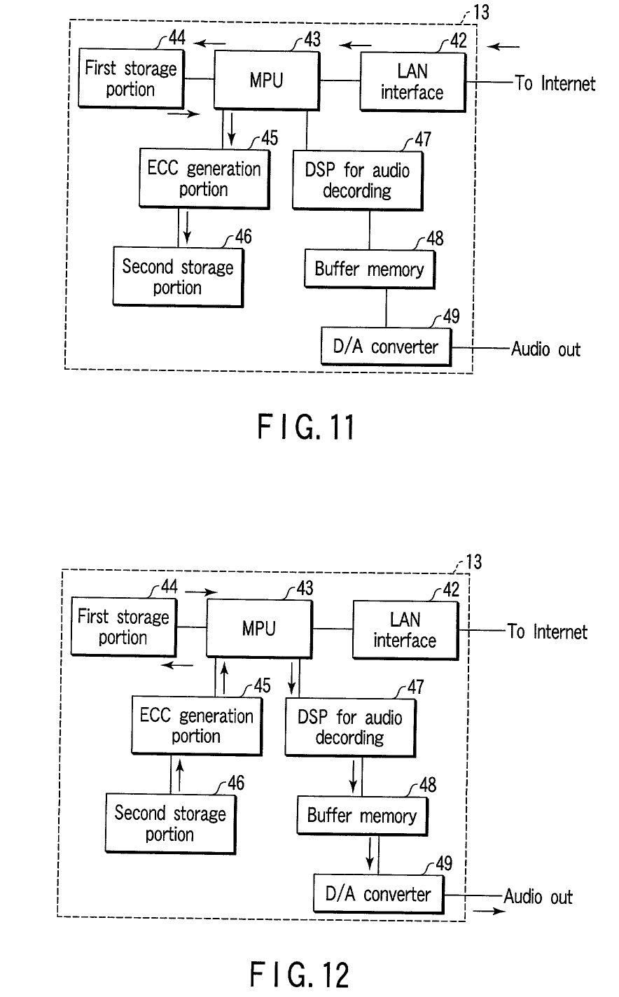

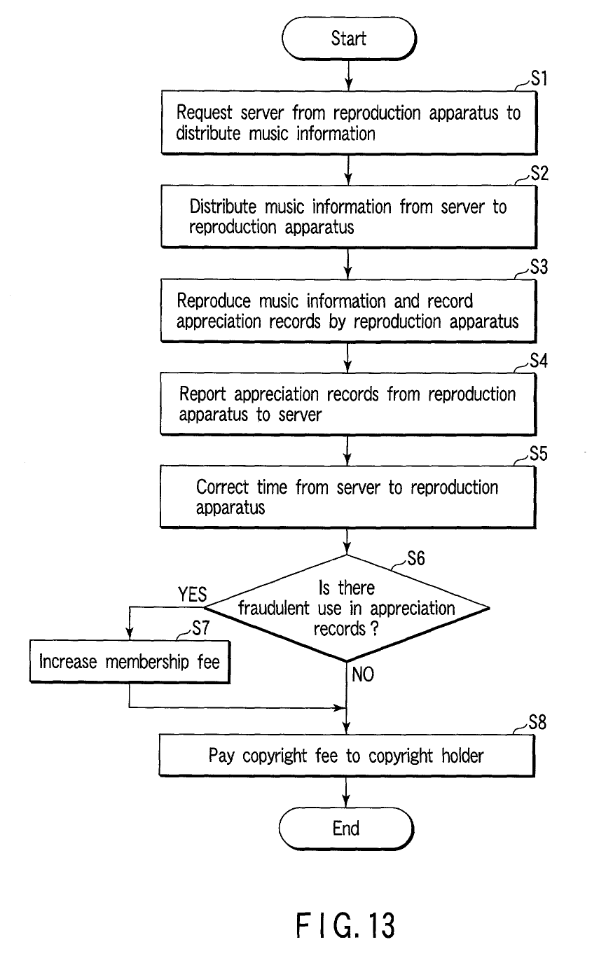

FIG. 13 is a flowchart showing the operation in the music distribution system.

A member 41 who has subscribed to the system administered by the membership fee system can register a plurality of music reproduction apparatuses 13. If a number of the registered music reproduction apparatuses 13 is within a predetermined number, an additional membership fee is not required. When it exceeds the predetermined number, the member must pay some additional charge.

The music reproduction apparatus 13 registered by the member 41 first requests the server 11 of the administration company to distribute desired music information (step S1). Alternatively, the server 11 transmits to the music reproduction apparatus 13 a list of distributable music information. The music reproduction apparatus (member) 13 selects music information from the received list of the music information and requests distribution of the selected music information. The server 11 distributes the requested music information to the music reproduction apparatus 13 through the Internet 12 (step S2).

Subsequently, the member 41 reproduces the music information by the music reproduction apparatus 13 and listens to music. At this moment, the music reproduction apparatus 13 stores the reproduced music information and its time (which will be referred to as a reproduction time hereinafter) in a storage portion in the apparatus 13 with reproduction of the music information. As the reproduction time, for example, the universal time is used so that any problem is not generated in the various countries of the world. More specifically, the music reproduction apparatus 13 repeatedly reproduces the music information at a member's request. At this moment, the music reproduction apparatus 13 records the appreciation records such as the reproduced music information and its number of times of reproduction, a reproduction time at which each reproduction is carried out, and others in the storage portion in the music reproduction apparatus 13 (step S3).

Thereafter, the appreciation records are transmitted from the music reproduction apparatus 13 such as a personal computer (PC) or a portable terminal to the server 11 of the administration company at a predetermined frequency. That is, the appreciation records such as the music information, its number of times of reproduction, and a reproduction time at which each reproduction is carried out are reported from the music reproduction apparatus 13 to the server 11 (step S4).

Subsequently, the server 11 of the administration company receives the appreciation records of the music information and examines whether there is any fraudulent use in the appreciation records. For example, the reproduction times in the appreciation records reported from a plurality of the music reproduction apparatuses 13 registered by the same member are compared with each other, and whether there is the same reproduction time is examined (step S6). When it is determined that there is a fraudulent use, the membership fee is increased with respect to that member, or that member is charged with a penalty fee (step S7).

Incidentally, since the reproduction times in a plurality of the music reproduction apparatuses 13 are compared with each other, the respective music reproduction apparatuses 13 must share the same accurate time. Thus, in order to prevent the time that each music reproduction apparatus 13 has from being inaccurate, the time of the music reproduction apparatus 13 is corrected by using a signal from the server 11 when the music reproduction apparatus 13 reports the appreciation records to the server 11 (step S5). Further, when the portable terminal or the like which reproduces music can not be connected to the server 11 in real time, the time of the portable terminal may be indirectly corrected through a PC which relays information.

A source of income of the administration company is a membership fee periodically paid by each member in accordance with the agreement for utilizing this system, as described above. The administration company pays the copyright fee to the copyright holder 15 of the music information in accordance with the appreciation records of the music information (step S8).

Incidentally, although description has been given as to the method for distributing the music information and reporting the appreciation records by using the Internet, the present invention is not restricted thereto, and distribution of the music information, report of the appreciation records and others may be carried out by using any other communicating means such as a satellite. Furthermore, the music information may be distributed by using a storage medium such as a CD-ROM, a DVD-ROM or the like. Moreover, the system that each listener pays a fixed membership fee and administration is carried out by the membership fee system enabling use of a plurality of the music reproduction apparatuses can be similarly applied to the first to sixth embodiments mentioned above.

Eighth Embodiment

A music distribution system according to an eighth embodiment of the present invention will now be described. In the eighth embodiment, description will be given as to a technique for preventing the fraudulence which may be possibly performed in the music information distribution system according to the seventh embodiment.

As the fraudulence carried out in the seventh embodiment, there can be considered the fraudulence of tampering data concerning the appreciation results recorded in the storage portion in the music reproduction apparatus 13 (which will be referred to as appreciation record data hereinafter) as if the music information is reproduced even though the music information is not actually reproduced. Consequently, the appreciation records of specific music information are increased, and payment of the copyright fee is concentrated on a copyright holder who holds the copyright of this specific music information.

In order to prevent such fraudulence, it is good enough to establish a scheme that the appreciation records recorded in the storage portion in the music reproduction apparatus 13 can not be rewritten from an external interface (I/F). When the music reproduction apparatus 13 is decomposed and rewriting is directly performed in the inner storage portion, however, prevention is difficult.

As a countermeasure, the eighth embodiment has structures such as described in the following (1) to (4).

(1) As the storage portion which records the appreciation record data, there is used a first storage portion 44 which is provided in the music reproduction apparatus 13 and constituted by a non-volatile memory. Specific data other than the appreciation record data is recorded in the non-volatile memory 44 in advance. By recording the specific data in the non-volatile memory 44 in this manner, even if the music reproduction apparatus 13 is decomposed, the power supply is intercepted and then the appreciation record data recorded in the non-volatile memory 44 is tampered, it is possible to prevent the tampered appreciation record data from being recognized as effective data by utilizing the fact that the specific data can not be confirmed. This is possible because the specific data stored in the non-volatile memory is also deleted when the power supply is intercepted due to decomposition.

(2) In the technique (1), if the non-volatile memory 44 is a general static RAM (SRAM), a dynamic RAM (DRAM) or the like, the appreciation record data and the specific data stored in the non-volatile memory are not necessarily deleted when decomposition and reinstallation are carried out in a relatively short time.

Thus, in the technique (2), the non-volatile memory has a function for forcibly clearing the stored content as a function that this non-volatile memory has. If the stored content can be cleared when turning on the power supply, the appreciation record data can be prevented from being recognized as effective data by utilizing the fact that the specific data can not be confirmed.

(3) In the techniques (1) and (2), the non-volatile memory 44 is used for the storage portion storing therein the appreciation record data. However, taking the structure of the music reproduction apparatus 13 shown in FIG. 11 into consideration, the non-volatile memory 44 is not necessarily appropriate for the system configuration when the non-volatile memory 44 is used as a region storing the specific data other than the music information. A storage place which is most appropriate and economical for the system configuration is a second storage portion 46 which stores therein the music information and is constituted by a non-volatile memory.

However, since the specific data is not eliminated in the non-volatile memory 46 even if the power supply is intercepted, whether the power supply is intercepted can not be determined based on whether the specific data can be confirmed. Thus, in the technique (3), a non-volatile memory region with only a predetermined capacity which has a function that data is reset when turning on the power supply is provided in a chip in which the non-volatile memory 46 is formed. In addition, the specific data is stored in the nonvolatile memory region in the non-volatile memory 46. As a result, when the power supply to the non-volatile memory 46 is intercepted and the appreciation record data is tampered, the specific data is eliminated. Therefore, it is possible to make judgment upon whether the power supply is intercepted and the appreciation record data is tampered based on whether the specific data can be confirmed.

(4) In the technique (3), although the non-volatile memory region is provided in the same chip as that of the non-volatile memory, such a configuration is not necessarily economically appropriate as a semiconductor memory.

Thus, in the technique (4), the appreciation record data is recorded in the non-volatile memory 46, and the non-volatile memory 46 is provided with a function for generating a random number when turning on the power supply, thereby checking whether the non-volatile memory 46 does not experience power-off.

Whether the non-volatile memory 46 experiences power-off can be checked by the following operation.

Description will be first given as to means of the non-volatile memory 46, which generates a random number when turning on the power supply.

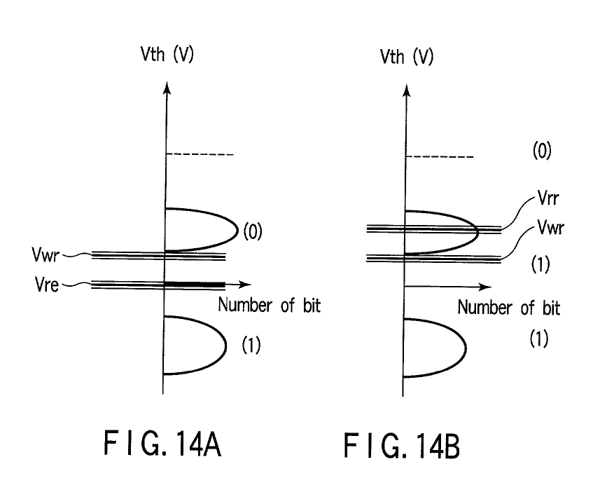

FIG. 14A is a graph showing a threshold voltage Vth(V) distribution and a regular reading voltage of a memory cell in a prior art flash memory, and FIG. 14B shows a threshold voltage Vth(V) distribution and a reading voltage at the time of occurrence of a random number of a memory cell in the non-volatile memory according to the eighth embodiment.

As shown in FIG. 14A, since the memory cell written with a writing threshold voltage Vwr is usually read with a reading voltage Vre, read data does not become unstable. When a random number occurs, as shown in FIG. 14B, reading is carried out with a reading voltage Vrr which is higher than the writing threshold voltage Vwr and in the vicinity of the center of the threshold voltage distribution of the writing cell. As a result, the read data becomes either “0” or “1”, which is very unstable. As a result, it is possible to generate a random data string similar to that at the time of occurrence of a random number.

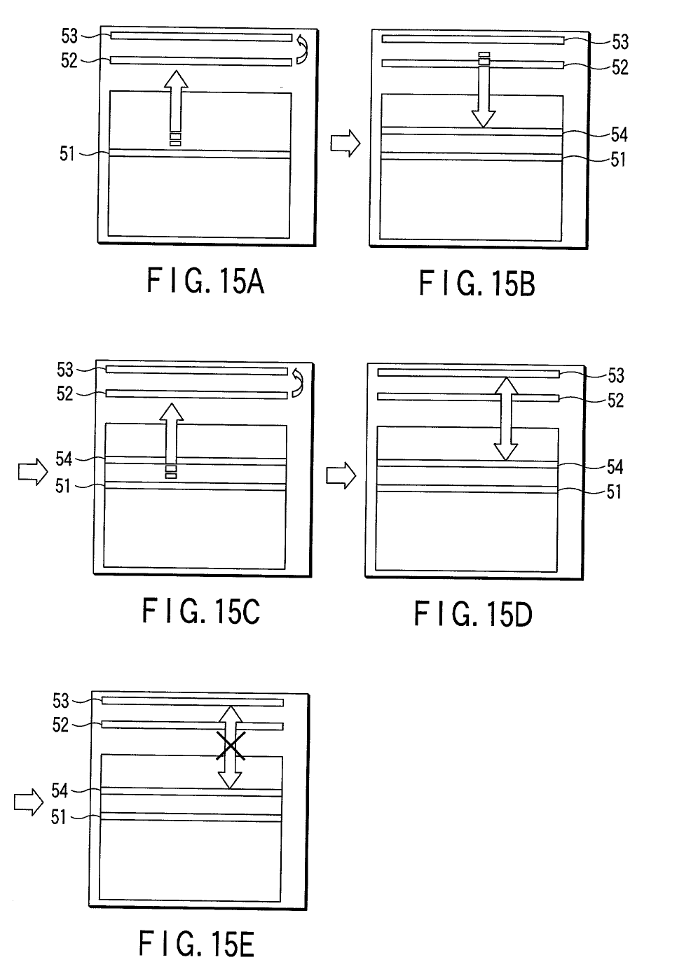

FIGS. 15A to 1SE are schematic views of the memory structures showing a series of the operations in the non-volatile memory for checking whether power-off is effected.

As shown in FIG. 15A, when the power supply is turned on, data is read from a specific page address 51 to a predetermined storage region with a reading voltage Vrr for generation of a random number. The data read into the storage region 52 is copied to a predetermined register 53. Subsequently, as shown in FIG. 15B, the data stored in the predetermined register 53 is copied in a storage region 54 of the non-volatile memory 46.

Thereafter, the power supply to the non-volatile memory is intercepted, and the appreciation record data is tampered. Then, when the power supply is again turned on, as shown in FIG. 15C, the data is read from the specific page address 51 to the storage region 52 with the reading voltage Vrr for generation of a random number. In this reading, since reading is carried out in a region where the threshold voltage is unstable, the precedently read data is not reproduced. Subsequently, the data read into the storage region 52 is copied to the predetermined register 53.

Then, as shown in FIG. 15D, data stored in a storage region 54 of the non-volatile memory 46 is compared with the data stored in the predetermined register 53. When the two sets of data coincide with each other, it is determined that power-off is not experienced and the appreciation record data stored in the non-volatile memory is effective. On the other hand, as shown in FIG. 15E, when the two sets of data do not coincide with each other, it is determined that power-off is experienced and the appreciation record data stored in the non-volatile memory 46 is invalid.

It is to be noted that a method for performing reading from a threshold voltage distribution region where the storage state is intentionally set unstable in the non-volatile memory can be used in the above-described random number generating means.

That is, the threshold voltage of the writing cell is intentionally recorded in the vicinity of a reading voltage in advance. When each writing cell is read, reproducibility of the read data as a random number becomes very low. In particular, if the reading data is constituted by multiple bits, it is difficult for the read data stored in the storage region 54 at the time of precedent power-on and the read data stored in the register 53 at the time of current power-on to coincide with each other.

Additionally, in order to make a reading result form the non-volatile memory unstable, the voltage steps of the reading voltage during reading can be very fine steps and a reading result obtained by a different reading voltage may be utilized.

The embodiments according to the present invention construct, in the music distribution (purchase of a listening right on the net) method in the information communication system such as the Internet, a site which realizes payment of the copyright fee based on the utilization records and reduction in music-listening fee with income of an advertisement fee in order to bridge the chasm between a copyright holder who requests payment and a consumer who expects a low price. Further, various kinds of combinations or modifications of the embodiments according to the present invention can be carried out without departing from the scope of the present invention.

As described above, according to the embodiments of the present invention, in order to satisfy a request for lowering the price by a listener, and a request for preventing infringement of right by a copyright holder, it is possible to provide the music distribution system which can collect a music-listening fee paid by the listener in accordance with the music appreciation records (number of times of reproduction), reduce the music-listening fee with income of an advertisement fee from the advertisement and general publicity, and pay a copyright fee to a copyright holder in accordance with the appreciation records.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A music distribution method comparing:
requesting a server to distribute music information from a music reproduction apparatus through a communication medium;
generating by said server a distribution file in which said music information requested and information concerning settings and conditions required for transmitting information from said music reproduction apparatus to said server are integrated;
distributing by said server said distribution file to said music reproduction apparatus through said communication medium; and
receiving by said server through said communication medium a number of times of reproduction of said music information reproduced by said music reproduction apparatus.

2. The music distribution method according to claim 1, further comprising requesting by said server to said music reproduction apparatus through said communication medium payment of a music-listening fee in accordance with said number of times of reproduction of said music information.

3. The music distribution method according to claim 1, wherein said communication medium is the Internet.

4. The music distribution method according to claim 3, wherein said information concerning said settings and conditions includes an Internet IP address required for reporting said number of times of reproduction of said music information from said music reproduction apparatus to said server.

5. The music reproduction method according to claim 1, wherein said server receives said number of times of reproduction of said music information at a given frequency.

6. A music distribution method comprising:
requesting by a music reproduction apparatus to a server distribution of music information through a communication medium;
receiving by said music reproduction apparatus from said server through said communication medium a distribution file in which said music information requested and information concerning settings and conditions required for transmitting information from said music reproduction apparatus to said server are integrated;
reproducing by said music reproduction apparatus said music information in said distribution file;
recording by said music reproduction apparatus a number of times of reproduction of said music information reproduced; and
transmitting by said music reproduction apparatus said number of times of reproduction of said music information to said server through said communication medium.

7. The music distribution method according to claim 6, further comprising receiving by said music reproduction apparatus a music-listening fee payment request according to said number of times of reproduction of said music information, which is transmitted from said server through said communication medium.

8. The music distribution method according to claim 6, wherein said communication medium is the Internet.

9. The music distribution method according to claim 8, wherein said information concerning settings and conditions includes an Internet IP address required for reporting said number of times of reproduction of said music information from said music reproduction apparatus to said server.

10. The music distribution method according to claim 6, wherein said music reproduction apparatus transmits said number of times of reproduction of said music information at a given frequency.

11. A music distribution method comprising:
requesting a server to distribute music information from a music reproduction apparatus through a communication medium;
generating by said server a distribution file in which said music information requested, advertisement information and information concerning settings and conditions required for transmitting information from said music reproduction apparatus to said server are integrated;
distributing by said server said distribution file to said music reproduction apparatus through said communication medium; and
receiving by said server through said communication medium a number of times of reproduction of said music information and a number of times of reproduction of said advertisement information reproduced by said music reproduction apparatus.

12. The music distribution method according to claim 11, further comprising:
requesting by said server to said music reproduction apparatus through said communication medium payment of a music-listening fee in accordance with said number of times of reproduction of said music information; and
requesting by said server to an advertiser through said communication medium payment of an advertisement fee in accordance with a number of times of reproduction of said advertisement information.

13. The music distribution method according to claim 11, wherein said communication medium is the Internet.

14. The music distribution method according to claim 13, wherein said information concerning settings and conditions includes an Internet IP address required for reporting said number of times of reproduction of said music information and said number of times of reproduction of said advertisement information from said music reproduction apparatus to said server.

15. The music distribution method according to claim 11, wherein said serer receives said number of times of reproduction of said music information and said number of times of reproduction of said advertisement information at a given frequency.

16. The music distribution method according to claim 11, wherein said distribution file has a header information portion and a main body information portion arranged under said header information portion, and a structure in which said information concerning settings and conditions and said advertisement information are recorded in said header information portion and said music information is recorded in said main body information portion.

17. The music distribution method according to claim 11, wherein said distribution file has a header information portion and a main body information portion arranged under said header information portion, and a structure in which said music information is recorded in said main body information portion and said information concerning settings and conditions and said advertisement information are included in said music information.

18. The music distribution method according to claim 11, wherein said music information and said advertisement information have relevancy, and said music information and said advertisement information are selected in such a manner that the population of listener who prefer songs according to said music information matches with the population of audiences to which advertisement and general publicity according to said advertisement information should be carried out.

19. The music distribution method according to claim 11, wherein said music information and said advertisement information do not have relevancy, and said advertisement information is selected in such a manner that a given advertisement is reproduced with a predetermined timing and at a predetermined time in favor.

20. The music distribution method according to claim 11, wherein said advertisement information has a plurality of sets of information corresponding to respective output modes in such a manner that said music reproduction apparatus can select at least any one of a banner advertisement, a character output and an audio output in accordance with an output mode thereof.

21. A music distribution method comprising:
requesting by a music reproduction apparatus to a server distribution of music information through a communication medium;
receiving by said music reproduction apparatus from said server through said communication medium a distribution file in which said music information requested, advertisement information and information concerning settings and conditions required for transmitting information from said music reproduction apparatus to said server are integrated;
reproducing by said music reproduction apparatus said advertisement information with reproduction of said music information;
recording by said music reproduction apparatus a number of times of reproduction of said music information reproduced and a number of times of reproduction of said advertisement information; and
transmitting by said music reproduction apparatus to said server through said communication medium said number of times of reproduction of said music information and said number of times of reproduction of said advertisement information.

22. The music distribution method according to claim 21, further comprising receiving by said music reproduction apparatus a music-listening fee payment request according to said number of times of reproduction of said music information which is transmitted from said server through said communication medium.

23. The music distribution method according to claim 21, wherein said communication medium is the Internet.

24. The music distribution method according claim 23, wherein said information concerning settings and conditions includes an Internet IP address required for transmitting said number of times of reproduction of said music information and said number of times of reproduction of said advertisement information from said music reproduction apparatus to said server.

25. The music distribution method according to claim 21, wherein said music reproduction apparatus transmits said number of times of reproduction of said music information and said number of times of reproduction of said advertisement information at a given frequency.

26. The music distribution method according to claim 21, wherein said music reproduction apparatus has a transmission/reception device and a portable reproduction device, said transmission/reception device receiving said distribution file from said server and transmitting said distribution file to said portable reproduction device, said portable reproduction device reproducing said music information and said advertisement information in said distribution file and transmitting said number of times of reproduction of said music information and said number of times of reproduction of said advertisement information to said transmission/reception device, said transmission/reception device transmitting said number of times of reproduction of said music information and said number of times of reproduction of said advertisement information received to said server.

27. The music distribution method according to claim 21, wherein said music reproduction apparatus has a transmission/reception device and a portable reproduction device, said transmission/reception device receiving said distribution file from said server and transmitting said distribution file to said portable reproduction device, said portable reproduction device keeping said distribution file therein for a given period of time and then transmitting it to said transmission/reception device, said transmission/reception device calculating estimated values for numbers of times of reproduction of said music information and said advertisement information based on a keeping period in said portable reproduction device when said distribution file is returned from said portable reproduction device and transmitting the obtained values to said server.

28. The music distribution method according to claim 21, wherein said distribution file has a header information portion and a main body information portion arranged under said header information portion, and a structure in which said information concerning settings and conditions and said advertisement information are recorded in said header information portion and said music information is recorded in said main body information portion.

29. The music distribution method according to claim 28, wherein said music information recorded in said main body information portion includes specific information which can specify said advertisement information, and said music reproduction apparatus is allowed to reproduce said music information when said advertisement information in said header information portion coincides with said specific information included in said music information in said main body information portion.

30. The music distribution method according to claim 21, wherein said distribution file has a header information portion and a main body information portion arranged under said header information portion, and has a structure in which said music information is recorded in said main body information portion and information concerning settings and conditions and said advertisement information are included in said music information.

31. The music distribution method according to claim 21, wherein said music information and said advertisement information have relevancy, and said music information and said advertisement information are selected in such a manner that the population of listeners who prefer songs according to said music information matches with the population of audiences to which advertisement and general publicity should be carried out according to said advertisement information.

32. The music distribution method according to claim 21, wherein said music information and said advertisement information have no relevancy, and said advertisement information is selected in such a manner that a given advertisement is reproduced with a predetermined timing and at a given time in favor.

33. The music distribution method according to claim 21, wherein said advertisement information has a plurality of sets of information corresponding to each output mode in such a manner that said music reproduction apparatus can select at least any one of a banner advertisement, a character output and an audio output in accordance with its output mode.

34. The music distribution method according to claim 26, wherein said advertisement information has a plurality of sets of information corresponding to each output mode in such a manner that said portable reproduction device can select at least any one of a banner advertisement, a character output and an audio output in accordance with its output mode.

35. The music distribution method according to claim 21, wherein said advertisement information is reproduced during reproduction of said music information.

36. The music distribution method according to claim 21, wherein said advertisement information is reproduced before or after reproduction of said music information.

37. A music distribution method comprising:
requesting by a music reproduction apparatus to a server distribution of music information through a communication medium;
receiving by said music reproduction apparatus said music information requested from said server through said communication medium;
receiving by said music reproduction apparatus information concerning settings and conditions and a plurality of sets of advertisement information from said server through said communication medium;
selecting by said music reproduction apparatus any advertisement information to be reproduced from a plurality of sets of said advertisement information when reproducing said music information;
reproducing by said music reproduction apparatus said selected advertisement information with reproduction of said music information;
recording by said music reproduction apparatus a number of times of reproduction of said music information reproduced and a number of times of reproduction of said advertisement information; and
transmitting by said music reproduction apparatus said number of times of reproduction of said music information and said number of times of reproduction of said advertisement information to said server through said communication medium.

38. The music distribution method according to claim 37, further comprising receiving by said music reproduction apparatus a music-listening fee payment request according to said number of times of reproduction of said music information, which is transmitted from said server through said communication medium.

39. The music distribution method according to claim 37, wherein said communication medium is the Internet.

40. The music distribution method according to claim 39, wherein said information concerning settings and conditions includes an Internet IP address required when said music reproduction apparatus reports said number of times of reproduction of said music information and said number of times of reproduction of said advertisement information to said server.

41. The music distribution method according to claim 37, wherein said music reproduction apparatus transmits said number of times of reproduction of said music information and said number of times of reproduction of said advertisement information at a given frequency.

42. The music distribution method according to claim 37, wherein said advertisement information has a plurality of sets of information corresponding to each output mode in such a manner that said music reproduction apparatus can select at least any one of a banner advertisement, a character output and an audio output in accordance with its output mode.

43. The music distribution method according to claim 37, wherein said advertisement information is reproduced during reproduction of said music information.

44. The music distribution method according to claim 37, wherein said advertisement information is reproduced before or after reproduction of said music information.

45. A music reproduction apparatus which reproduces music information distributed from a server, comprising:
means for requesting said server through a communication medium to distribute said music information;
means for receiving from said server through said communication medium a distribution file in which said music information requested to be distributed and information concerning settings and conditions required for transmitting information from said music reproduction apparatus to said server are integrated;
means for reproducing said music information in said distribution file;
means for recording a number of times of reproduction of said music information reproduced; and
means for transmitting said number of times of reproduction of said music information to said server through said communication medium.

46. A server which distributes music information to a music reproduction apparatus, comprising:
means for receiving a request of distribution of said music information from said music reproduction apparatus through a communication medium;
means for generating a distribution file in which said music information requested to be distributed, advertisement information and information concerning settings and conditions required for transmitting information from said music reproduction apparatus to said server are integrated;
means for distributing said distribution file to said music reproduction apparatus through said communication medium; and
means for receiving through said communication medium a number of times of reproduction of said music information and a number of times of reproduction of said advertisement information reproduced by said music reproduction apparatus.
